(19) United States
(12) Patent Application Publication
(10) Pub. No.: US 2023/0092783 A1
(43) Pub. Date: Mar. 23, 2023

(54) BOTCASTS - AI BASED PERSONALIZED PODCASTS

(71) Applicant: MICROSOFT TECHNOLOGY LICENSING, LLC, Redmond, WA (US)

(72) Inventors: Karen MASTER BEN-DOR, Kfar Saba (IL); Adi DIAMANT, Tel Aviv (IL); Stav YAGEV, Tel Aviv (IL); Eshchar ZYCHLINSKI, Tel Aviv (IL); Yoni SMOLIN, Yokne'am Illit (IL)

(21) Appl. No.: 17/530,068

(22) Filed: Nov. 18, 2021

Related U.S. Application Data
(60) Provisional application No. 63/247,242, filed on Sep. 22, 2021.

(51) Int. Cl. G06N 5/04; H04L 29/08; G06F 3/16

(52) U.S. Cl. CPC G06N 5/04; H04L 67/306; G06F 3/165

(57) ABSTRACT

Systems and methods are provided for configuring and utilizing botcasts, which comprise audio content with transitions corresponding to the audio content, to facilitate accessibility and presentation of the media content within the botcasts according to contextual relevance for different individual users. The systems identify, access, filter, augment, customize, personalize, create and/or otherwise configure the media content, as well as the content transitions in the botcasts, according to the individual preferences and profiles of each user, as well as the contextual circumstances for each user.

### CROSS-REFERENCE TO RELATED APPLICATIONS

This application claims the benefit of and priority to U.S. Provisional Patent Application Ser. No. 63/247,242 filed on Sep. 22, 2021, and entitled “BOTCASTS—AI BASED PERSONALIZED PODCASTS,” and which application is expressly incorporated herein by reference in its entirety.

### BACKGROUND

There are many tools and platforms designed to assist with the creation, publication, and consumption of media content. The Internet, for example, stores and indexes a variety of media content, including audio content, literary content, and mixed-media content, all of which can be searched and rendered with specialized browsers, media players and other specialized user interfaces.

One type of content that is accessible through the Internet includes podcasts. Podcasts, which are configured as audio files categorized within genres or topics, have become popular, at least in part, because of the ease in which the underlying content can be tagged and categorized and for enabling consumers to search for podcasts containing content of that may be of interest to the consumers. Some podcasts are published without restrictions and/or for consumption by the public-at-large. Other podcasts are restricted and are only available to subscribers or users having verifiable credentials.

The search tools and functionality provided by browsers for enabling users to search for podcasts can also be used to search for other types of media content available on the Internet, as well as to search for content saved on other public and private enterprise storage systems. For example, many conventional browsers and media players are configured with query tools that enable users to search for and identify media from any accessible and indexed storage location that contains content associated with a specified keyword or attribute of interest to the user (e.g., file type, format, size, duration, creation date, author, etc.).

However, despite existing search functionality provided by existing browsers and media players, many users still struggle finding and consuming the content that is relevant to their current needs and desires. Some of these difficulties are based on compatibility problems between the formatting of the content and the browsers/players that are used to render the content. In particular, not all media players and devices are configured to render all types of media content, particularly in all of the disparate formats and resolutions in which the media is capable of being created in.

Logistical time constraints can also impede the manner in which users are able to find and consume media that is most relevant to their current needs and desires. For instance, some content is published at times when users are busy or unavailable, such as when they are sleeping, eating, driving, working, etc. Likewise, even when users are available to search for desired content, they may not have the time to consume all of the content that they found or that is available. The foregoing problems can be made even worse when the desired content, such as a particular snippet of an audio recording, is buried within a relatively large and lengthy media file that the user does not have time to listen to.

Distribution constraints can also negatively affect a consumer's ability to find and obtain specific content that is relevant to their current needs and desires. In particular, some publishers try to generalize their content in an effort to make their content more palatable and broadly applicable to many different interests and parties by casting a wide net, by essentially addressing many different concepts within a single publication and/or by restating the same content in many different ways within the same media product. This type of media is very commercially viable because it can resonate with a relatively large and diverse base of consumers that have differing perspectives and interests. However, this type of media will inevitably include various content that is not particularly relevant and/or of interest to each and every individual consumer. This can be problematic, however, in instances when a consumer is searching for specific content that is of interest to them within a particular media product but does not have the time or desire to consume all of the content within that media product that is not particularly relevant or of interest to them.

Additional problems experienced by users are associated with identifying, assembling and consuming media content from multiple sources into a single compiled audio file, for example, to enable the user listen to the compiled content in a seamless fashion. These problems include difficulties and inefficiencies associated with users having to access all of the content sources, make redundant copies of desired content from the different sources, formatting the content into consistent or common media formats, editing the content to omit undesired content and to improve transitions between the different content snippets, and compiling the snippets into a single composite media file. All of the computational resources and time required to perform these processes are somewhat prohibitive, particularly when trying to compile many different portions of content from many different sources.

These difficulties and problems are further exacerbated when user schedules with different meetings and events cause the relative importance and relevance of the different media content to change over time and in response to different contextual circumstances the users experience. In particular, because of these dynamic changes, an initial intention or purpose for compiling the media content by the user (e.g., to prepare for a meeting or event) may change unexpectedly and at times that are inconvenient for the user to recompile a new file of media content that is more relevant for the user and, particularly, when the user needs to review or access other content that is more relevant to a new scheduling event, for example.

In view of the foregoing, as well as other problems existing within the field of media distribution and consumption, there is an ongoing need and desire to provide new and improved products, systems, and methods for identifying, accessing, and presenting content to consumers, and particularly for providing content to users in a manner that is more contextually relevant and/or personalized for individual users than is currently enabled by conventional browsers, media players and media products.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

New and improved methods, systems, products, and devices are provided for identifying, accessing, and presenting media content to different users.

The disclosed embodiments that provide this functionality include methods, systems, and devices for identifying, accessing, filtering, augmenting, customizing, personalizing and/or otherwise modifying media content for user consumption. These embodiments are operable for facilitating the accessibility and presentation of the media content in a personalized or customized manner to the individual users.

In some instances, the disclosed embodiments include generating unique and/or customized botcasts for a plurality of different users, where each botcast comprises an audio file of assembled/compiled audio content that is personalized for each individual user. The assembled/compiled audio content for a user's botcast comprises similar underlying audio content, the same underlying audio content and/or different underlying audio content than the audio content that is assembled/compiled for the same user in different contextual circumstances and/or that is assembled/compiled for different user botcasts, according to the different user preference and profile settings and/or different contextual circumstances. During the generation of the botcast, the audio content that is selected, formatted, augmented, summarized, filtered and/or otherwise modified for each botcast is done so in a manner that is determined to be of a personal interest and/or of a contextual relevance for each corresponding individual user according to their preference and profile settings and/or current contextual circumstances.

The disclosed embodiments include, for example, systems and methods for configuring and/or utilizing a botcast of media content customized for a particular user. These embodiments include systems identifying and analyzing selected content to include in a botcast for a particular user based on one or more profile or preference settings associated with the particular user (which may include contextual circumstances associated with the particular user), as well as for generating a transition associated with the selected content that is personalized to the particular user and that will be assembled into the botcast with the selected content to identify the relevance of the content to the user.

The transition includes audio that is supplementary to the selected content and includes at least one of an identification of a relevance of the selected content to the particular user based on the one or more profile or preference settings associated with the particular user, and/or a summary of the selected content that is formatted in a selected summary format that is selected from a plurality of available different summary formats, each of which is based on the one or more profile or preference settings associated with the particular user and which setting may include contextual circumstances associated with the particular user.

The disclosed embodiments also include systems sequencing the selected content with the transition sequence into a playback sequence that is used by media players for presenting and/or rendering the botcast transition(s) and content in the ordered sequence. This sequencing may also be based on the profile/preference settings and/or contextual circumstances associated with the particular user.

The disclosed embodiments also include systems formatting and/or otherwise linking or assembling the selected content and transition(s) into a digital structure comprising the botcast and with the selected content and transition(s) being stored in an audio format or audio playable format that is selected from a plurality of different audio/audio playable formats, the audio/audio playable format being selected from the plurality of different formats based on the one or more profile or preference settings associated with the particular user and which may include contextual circumstances associated with the particular user.

Some embodiments also include providing the botcast to an audio player that renders the botcast (including the selected content and transition(s)) according to the ordering of the botcast sequence and in the format selected for the botcast, based on the particular user settings/circumstances.

Other embodiments also include modifying the botcast for the same user and/or for different users, based on detecting different dynamic changes to user settings, available content and/or contextual circumstances for the user/different users. Such modifications can include adding new content and/or removing content from the botcasts, based on a detected increase/decrease in relevance of the content, respectively, for the different users. The modifications can also include reordering/resequencing of the content and/or transitions in the botcast, reformatting of the content/transitions into different playback audio formats, and/or creating, augmenting, deleting, or otherwise modifying the transitions/content in the botcast.

Yet other embodiments include storing, publishing and/or playing the botcasts.

This Summary is provided to introduce a selection of concepts in a simplified form that are further described below in the Detailed Description. This Summary is not intended to identify all of the key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates a computing environment in which a computing system incorporates and/or is utilized to perform disclosed aspects of the disclosed embodiments for configuring, generating and/or otherwise utilizing personalized botcasts.

FIG. 2 illustrates an embodiment of system model components and a flow corresponding to the overall generation, configuration and/or utilization of personalized botcasts.

FIGS. 3A-3C illustrate various example embodiments of user interfaces for selecting content for personalized botcasts.

FIG. 4 illustrates an embodiment of a user interface for selecting segmented content that has been segmented for selection and inclusion into personalized botcasts.

FIGS. 5-7 illustrate various example embodiments of user interfaces for selecting content for a personalized botcast.

FIGS. 8-10 illustrate various example embodiments of user interfaces and interface components for selecting content for personalized botcasts.

FIG. 11 illustrates an embodiment of a botcast user interface media player that is showing different personalized botcasts and their current statuses;

FIG. 12 illustrates an embodiment of a botcast user interface media player that is currently playing a personalized botcast; and

FIG. 13 illustrates one embodiment of a flow diagram having a plurality of acts associated with methods for configuring, generating and/or utilizing personalized botcasts.

### DETAILED DESCRIPTION

Disclosed embodiments include methods, systems, products, and devices for identifying, accessing and/or for presenting media in a personalized/customized format for individual users. These embodiments include methods, systems, and devices for identifying, accessing, filtering, augmenting, customizing, personalizing and/or otherwise modifying media content with corresponding content transitions for user consumption in the form of a botcast.

The disclosed botcasts comprise files of selected media content from one or more media sources, as well as transitions that are created for the different media content contained in the botcast. The media content and transitions in the botcasts are selected, created, sequenced and/or formatted in a customized/personalized manner based one or more user profile or preference settings and contextual circumstances associated with the particular user/users for whom the botcasts are created.

There are many technical benefits associated with the disclosed embodiments, including the functionality of systems utilizing different machine learning modules to personalize and customize content and create corresponding content transitions. The technical benefits also include improved efficiency in identifying, assembling, and formatting content of a variety of underlying formats for playback and consumption by different users that have different system capabilities that may not initially be operable to render/play all of the underlying formats in a desired playback format.

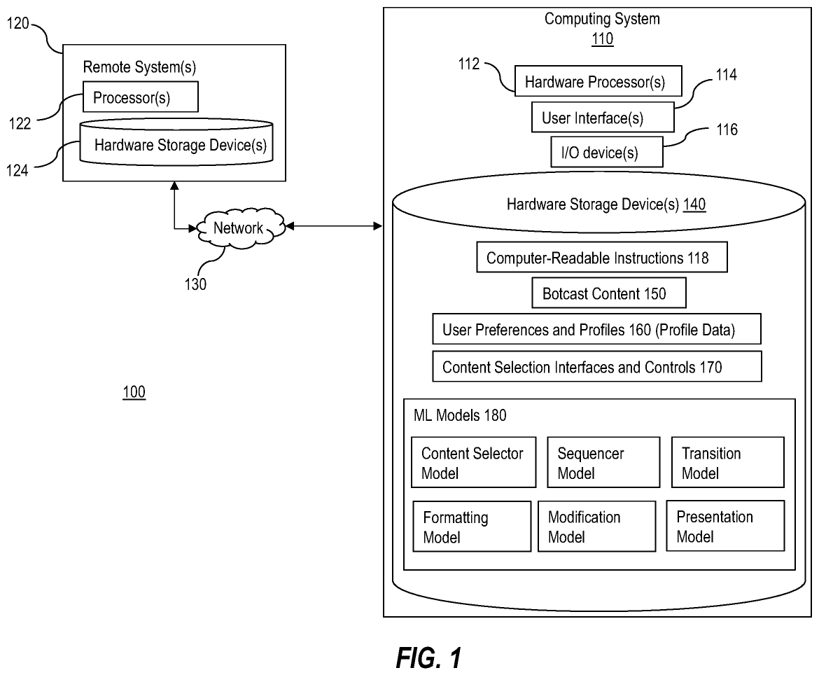

Attention will now be directed to FIG. 1, which illustrates components of a computing system 110 which may include and/or be used to implement aspects of the disclosed invention.

The computing system 110 is illustrated as being incorporated within a broader computing environment 100 that also includes one or more remote system(s) 120 communicatively connected to the computing system 110 through a network 130 (e.g., the Internet, cloud, or other network connection(s)). The remote system(s) 120 comprise one or more processor(s) 122 and one or more computer-executable instruction(s) stored in corresponding hardware storage device(s) 124, for facilitating processing/functionality at the remote system(s), such as when the computing system 110 is distributed to include remote system(s) 120.

The computing system 110, as described herein, incorporates and/or utilizes various components that enable the disclosed functionality for configuring and utilizing botcasts and other similar products/structures. The functionality and processing performed by and/or incorporated into the computing system 110 and the corresponding computing system components includes, but is not limited to, identifying, accessing, filtering, augmenting, customizing, personalizing and/or otherwise modifying media content for user consumption in the form of a botcast or other similar product/structure comprising audio content and corresponding transitions personalized for individual users.

In some instances, the disclosed functionality also includes generating and/or obtaining training data and training the disclosed models to perform the underlying and described functionality of each of the disclosed models and which functionality will be described in more detail throughout this disclosure.

FIG. 1 illustrates the computing system 110 and some of the referenced components that incorporate and/or that enable the disclosed functionalities. For example, the computing system 110, is shown to include one or more processor(s) 112 (such as one or more hardware processor(s)) and a storage 140 (i.e., hardware storage device(s)) storing computer-executable instructions 118 wherein the storage 140 is able to house any number of data types and any number of computer-executable instructions 118 by which the computing system 110 is configured to implement one or more aspects of the disclosed embodiments when the computer-executable instructions 118 are executed by the one or more processor(s) 112. The computing system 110 is also shown to include one or more user interface(s) 114 and input/output (I/O) device(s) 116.

The one or more user interface(s) 114 and input/output (I/O) device(s) 116 include, but are not limited to, speakers, microphones, vocoders, display devices, browsers, media players and application displays and controls for receiving and displaying/rendering user inputs and for accessing, selecting, formatting media content and for configuring and utilizing the disclosed botcasts.

In some instances, the user inputs received and processed by the user interface(s) 114 include user inputs for identifying and/or generating the referenced user preferences and profiles (160), for identifying or selecting media content to include in botcasts and for selecting and playing botcasts, as will be described in more details throughout this disclosure.

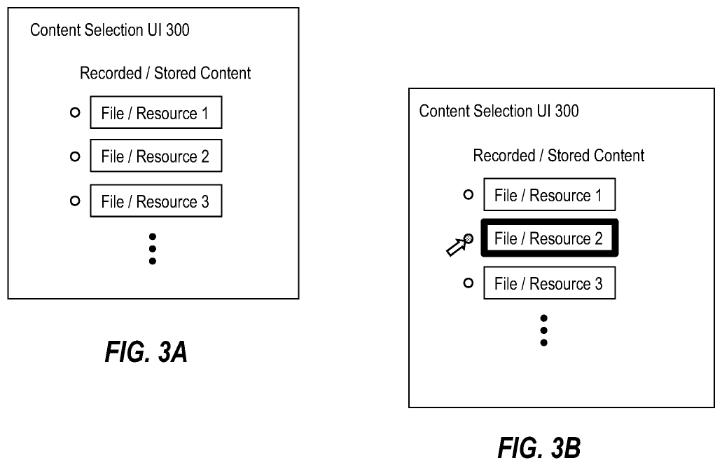

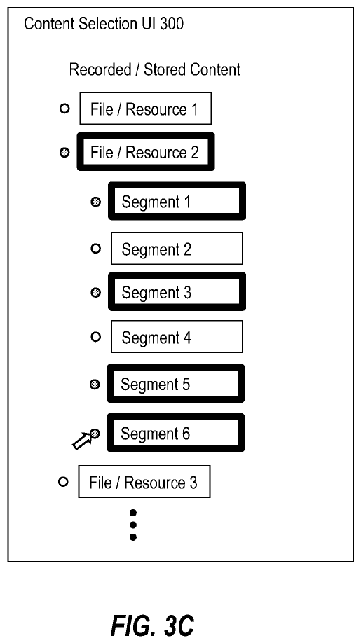

Various interface menus with selectable control element, stand-alone control objects and other control features are also included with the interface(s) 114, including the menus, icons, controls, and other objects described in reference to FIGS. 3A-12, and which are configured for receiving user input that is operable, when received, to trigger access to the referenced functionalities associated with configuring and utilizing the disclosed botcasts.

With regard to the term botcasts, it will be appreciated that the term botcast should be broadly interpreted to comprise a data structure or file that includes or operably links to media content and corresponding transitions created for the different media content in a sequenced ordering for sequenced playback in an audio format. The media content is preferably formatted into an audio format. However, some botcasts are configured with media and/or links to other media content that is not in a pure audio format (e.g., in a format comprising any combination of audio, text, image and/or video formatting) and which is accessed in real-time, during playback or rendering of the botcast, and transformed into audio for playback by the media player and/or systems used to access and render the botcast.

In these embodiments, the botcast may include or comprise a listing or links to media content to be rendered, along with instructions for how the media is to be transformed and/or rendered during playback, as well as the sequencing for playback. The botcasts also include transitions, created according to the disclosed embodiments, for providing relevance or summaries of the content that is played. In some instances, the transitions are prepended to the content they correspond to. In other instances, they are separate structures that are sequenced/linked to play prior to the content they correspond to.

All of the botcast media content, transitions, links, sequencing instructions, playback instructions, playback status and access event records are included in the referenced botcast content 150, which is stored in storage 140. In some instances, the botcast content 150 also includes a plurality of different botcasts corresponding to a single user or a plurality of different users. These botcasts can be stored and managed over time in a static state, without change to the content or the transitions. Additionally, in some instances, the botcasts are stored in a dynamic and modifiable format, such as when they are modified in view of different detected circumstances or user preferences and profiles 160, such that the botcasts can operate as a dynamic streaming channel, for example.

As presently shown, the storage 140 is configured to store the referenced user preferences and profiles 160 along with the botcasts, although they may be stored in different containers or locations of the storage 140.

The data included in the user preferences and profiles 160 is also sometimes referred to herein as preference and profile data or more simply as profile data. This profile data includes, but is not limited to, any combination of (i) language, prosody and/or other speech-related profile preferences, which reflect one or more preferential languages for particular users, (ii) calendar and schedule information associated with one or more calendars and scheduled events of particular users or user contacts, (iii) user account login and credential(s) for accessing one or more applications, media content resources, user calendar and meeting event interfaces, and/or other files and resources, (iv) learned or entered user preferences for topics of interest, hobbies, resources of media content, navigation histories and/or media playback preferences, (v) user device capabilities and characteristics, device logs and/or device usage histories, (vi) contacts, contact information, titles, responsibilities, memberships and/or assigned tasks or projects, (vii) location and address information associated with the users' residences, workplaces, places of travel, and/or other location information, (viii) tagged content and other explicitly identified user preferred content types, sources and/or topics, (ix) email, phone and/or other communication logs, and/or (x) any other information related to a user that may be used to identify potentially relevant content for the user.

In regard to the foregoing, therefore, it will be appreciated that the profile data will also include certain circumstantial and contextual information that is determined to be relevant to the corresponding users and/or that can be used to determine said relevance. For instance, the circumstantial and contextual information of the profile data may include, but is not limited to (i) weather and environmental conditions associated with user locations or events, (ii) meeting schedules, locations, attendees, participants, materials, credentials, access information, etc., (iii) current status, activities, map, travel and logistical information associated with the user, user events and other user contacts, (iv) reports, tasks, participants, equipment, progress and status information associated with projects or events associated with the users and user contacts, (v) and/or any other contextual information associated with circumstantially relevant environments, events and/or other conditions associated with the users and their other profile data.

It will also be appreciated that the profile data can take different forms and can be consolidated or distributed. This profile data can be stored, for instance, in one or more different data structures, with one or more different formats in local storage 140. These data structures can also include links or pointers to other profile/preference data that is stored separately within storage 140, such as in different directories or domains, and/or remotely from storage 140.

It will also be appreciated that the term user, as used herein, is sometimes interchangeable with the term entity. The term entity may be viewed as broader than the term user when the term user is interpreted as a single individual person. In particular, the term entity can apply to an entire enterprise or group composed of a plurality of individual people when that group is collectively associated with the organization, or another common affiliation.

Throughout this disclosure, the term user can be interpreted as either a single individual person or, alternatively, as an entity comprising a group of people, unless otherwise stated. Accordingly, when a user is interpreted as an entity comprising a plurality of individual users, each individual person of the collective entity may have their own profile data set stored in the preferences and profiles 160, as well as having an additional shared set of profile data that includes and/or that at least identifies common individual preferences and profiles for each of the individuals in the collective entity.

The system will create, access, update, store and/or otherwise utilize a separate corresponding set of profile data for each of the different user entities (e.g., groups, organizations and affiliations), each of which, for example, may specify correspondingly different roles, circumstances, contextual and/or other profile data for each of the different users within those different groups, organizations and affiliations and which may impact relative relevance of content to the different users and/or for the overall entities.

Currently, storage 140 is shown as a single storage unit. However, it will be appreciated that the storage 140 is, in some embodiments, a distributed storage that is distributed to several separate and sometimes remote systems 120. In this regard, it will be appreciated that the system 110 will comprise a distributed system, in some embodiments, with one or more of the system 110 components being maintained/run by different discrete systems that are remote from each other and that each perform different tasks. In some instances, a plurality of distributed systems performs similar and/or shared tasks for implementing the disclosed functionality, such as in a distributed cloud environment.

In some embodiments, storage 140 is also configured to store one or more of the following: content selection interfaces and controls 170, as well as the different machine learning or machine learned models (ML models 180) used to implement the functionality described herein, and which will now be described in more detail.

The content selection interfaces and controls 170 include, but are not limited to, menus and interfaces that display or reference content, interface tools and objects that enable a user to flag, tag or otherwise identify and select content for inclusion in a botcast and/or for botcast processing, interfaces and tools for parsing content and for segmenting content, interfaces, menus and tools for entering and/or selecting profile data, as well as interfaces and tools for selecting botcast media files to play and for playing/rendering and sharing or distributing the botcast media files. Some non-limiting examples of these content selection interfaces and controls 170 are reflected in FIGS. 3A-12.

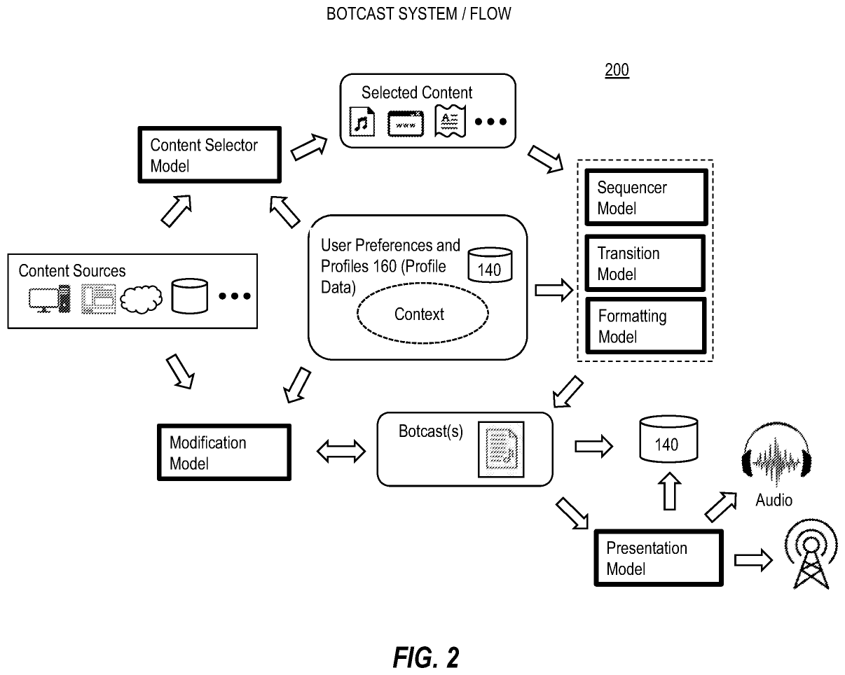

The ML models 180 that are utilized by the systems described herein to implement the disclosed functionality include, but are not limited, a content selector model, a sequencer model, a transition model, a formatting model, a modification model, and a presentation model. Each of these models is trained with training data to perform the different functions attributed to them. These functions and additional descriptions of the different ML models 180 will now be provided in reference to FIG. 2.

As shown, FIG. 2 illustrates various components and elements associated with the botcast systems referenced above, as well as a general flow and organization of processing that occurs by the various elements and ML models to implement the functionality for configuring and utilizing the botcasts described herein.

For instance, the content selector model accesses various content resources to identify relevant content and to select the content that is determined to be relevant to one or more users based on the profile data for those different users. The content selector model can operate automatically, based on the various profile data, and based on referencing directories of resources for the potential content it already has stored in storage 140.

The content selector can also respond to new and direct user input that identifies the content to be selected. In these instances, the content selector will utilize the aforementioned content selector interfaces and controls 170. Although the content selector interfaces and controls 170 are not shown in FIG. 2. It will be appreciated that they can still be utilized by the content selector, as well as each of the other referenced and described ML models to interface with the users, content and botcasts, to perform the described functionality.

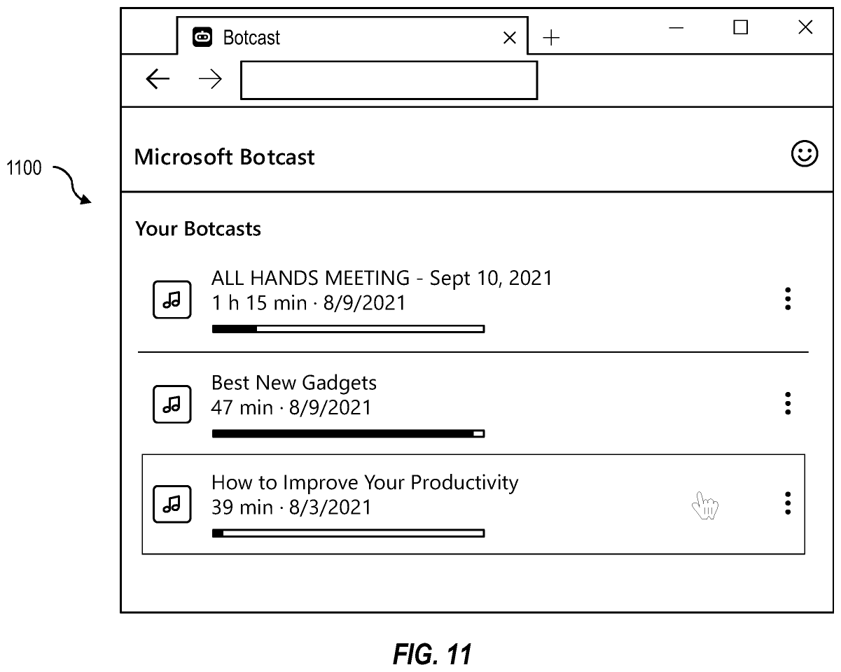

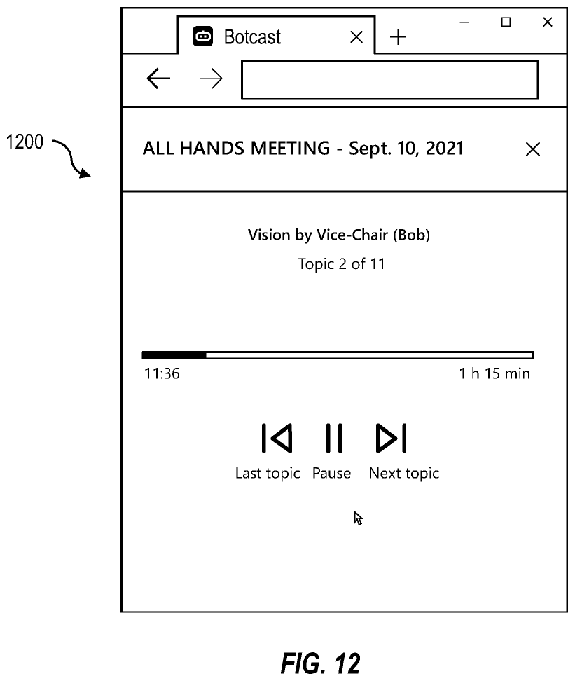

Some non-limiting examples of utilizing the content selector interfaces and controls 170 for receiving explicit user input for selecting the content are described in reference to FIGS. 3A-10 and some non-limiting examples of utilizing the content selector interfaces and controls 170 for interfacing with the botcasts (botcast media files) are shown in FIGS. 11 and 12.

The content selector is trained to search/crawl target resources for content that is determined to be relevant to the users based on their user profile data and/or based on newly received user input, which user input, when received is also used to update the user profile data. The content selector can perform both of these functions and is trained with training data to perform these functions. Details about how a ML model is trained will not be provided at this time, as training ML models is well known to those in the industry. However, by way of non-limiting example, the content selector can be trained with keyword and content source pairs, as well as keyword and resource content pairings, to learn associations and relevance of keywords to particular content sources/resources, as well as discrete segments or portions of different resources.

It will also be noted that the training data sets include pairing in which the pairings include content comprising text, audio, images, video and/or mixed media that includes combinations of text, audio, images and/or video along with characterization terms for the associated content.

The training data sets also include combinations of different media (e.g., text, audio, video, images) along with different terms, contexts or other characterizing information for the content that can be used to train the content selector model to characterize content and the relevance of the content to particular terms and contexts, such as the terms and contexts that are obtained from the user's profile data.

In some instances, the training data sets further include combinations of characterizations and content that enable the training of the content selector to perform analysis and processing of all types of content to determine possible characterizations of the content and potential relevance to the user's profile data. These different types of processing include but are not limited to combinations of natural language processing and analysis, image processing and analysis, context analysis, video analysis, body language analysis, intonation analysis, emotional processing, concept inclusion analysis and/or other processing and analysis of underlying content that enable the characterizations and relative importance of the content to corresponding user preferences and contexts.

Accordingly, the training data sets also include keywords in the pairings that are reflective of or that correspond to the user profile data, such terms, words, ideas, concepts, speech elements, media preferences, events, projects, tasks, locations, names and/or other elements that may be included in the user profile data. In this manner, the content selector model is trained to identify sources and resources that may be determined to be relevant to each particular user, based on correlations between determined characterizations of the content being considered and the terms/characterizations of the user preferences, profiles and contexts referenced in the user profile data.

The content selector model is also trained to prioritize or weight different elements of the profile data, as well as to determine significance and/or relevance of content to the user, based on the prioritized/weighted profile data elements of each user, and to thereby be able to determine the potential relevance of content that is discovered when the content selector identifies different content that may be of interest or that may be relevant to each user. This training and real-time analysis can be done at different levels of granularity, to determine the relevance of an entire resource (e.g., document or file) to a user, as well as to determine the relative relevance of different discrete segments within the resource to the user. For instance, if the content/resource identified by the content selector is an entire paper or book, the content selector model can determine a collective relevance of the entire resource, as well as the discrete segment relevance for each chapter, paragraph, or other portion of the content.

The determined relevance can be categorized by a numerical scale (e.g., 0-100) or by tier (e.g., High, Medium, Low) or by temporal relevance to impending events (e.g., very urgent, urgent, low urgency, no urgency, such as based on a corresponding urgency scale of event scheduled now, in next hour, next day, next month, respectively, etc.). The relevance can also be categorized by prevalence of discovered content that is similar or redundant (e.g., many articles, resources, podcasts, broadcasts, or other resources covering a common or similar topic/issue, as well as emails, voicemails or other communications that are determined to be directed to a common task, event, project, person, or topic, etc.). The relevance can also be a relative relevance, rather than a relevance of magnitude or category per se. For instance, the different items of content identified for a user for a particular botcast can be sorted in an ordering of relative relevance (e.g., reference C is more relevant than reference B, but less relevant than A reference, etc.)

In some instances, the content selector model is trained to identify a fixed number or quantity of content resources to use for the botcast. In other instances, the content selector model is trained to incorporate all content resources that meet a predetermined relevance threshold (e.g., all urgent content items and/or all references having a relevance of at least high relevance and/or all references having a relevance score of at least n-value, wherein n is a value in the range of 0 to a max value).

The content selector is also trained to parse and analyze the content/resources identified from the different sources to segment the content into different portions that are independently evaluated for determined relevance. In some instances, the relevance of each segment is further determined based on user input. For instance, in some instances, once the content selector model parses and segments the content into a plurality of segments, the content selector will cause the segments to be presented to the user for further selection of segments that are of interest to the user. Such an example is provided below, in reference to FIGS. 3B and 3C, where a user first select File/Resource 2 to access the specific segments of the File/Resource 2 that are of interest (i.e., segments 1, 3, 5 and 6), while leaving segments 2 and 4 unselected, such that the botcast will include the selected segments and omit the unselected segments from a base selected file. In this manner, the user can specifically identify the discrete segments/portions of a resource that are of most interest to the user for inclusion into the user's botcast, without requiring the user to have to listen to all of the different segments/portions of the resource. In other related embodiments, the content selector model automatically and independently determines which segments are sufficiently relevant to include in the botcast for the user.

The determined relevance of each content resource and/or resource segment is tracked and stored, in some instances, in a table or other data structure within the botcast content 150 mentioned in reference to FIG. 1. A separate relevance tracking table can be maintained separately for each user and/or each resource and/or collectively for a plurality of different users and/or resources. The content selector model (and other models) will reference the relevance tracking table(s) during implementation to identify content for inclusion in the botcasts, to identify transitions to use for the content and to update and calculate the relative relevance of other content to be included or excluded or modified for the different botcasts for each particular user.

In some instances, the content selector model is also trained to identify credentials, tokens and other verification and authentication information from the user profile data and to, likewise, identify requirements by the different content sources for verifying/authenticating the user to obtain access to the resources contained in the different content sources. In this manner, for example, the content selector model is enabled to access content from individual user accounts, such as personal email, voicemail, video conference, text and other personal communication applications and accounts, as well as from enterprise directories and databases associated with the user.

In regard to the selection of content from content sources, it will be appreciated that the content sources can include any public and/or private source of content that may be relevant to the users. This includes sources such as the world wide web (Internet), as well as enterprise systems, private and public databases, broadcast services, location services, as well as specific applications like email applications, event task and project scheduling applications, personal and business calendar applications, gaming applications, communication applications, location service applications, weather applications, and so forth.

The content selector model, once trained, can also use any new user input for tuning or refining the training of the content selector model. For instance, user input that explicitly identifies content to include or exclude from a botcast, or that provides new profile data and/or that is used to trigger the playing, sharing, or modifying of a botcast by the user can be used to update the stored profile data and to impact which relevance determinations are made for selecting the content to include in the botcasts.

In some instances, the content selector model, as well as the other models, will be trained to initiate their functionality/processing directly in response to a user input that explicitly requests the processing, such as the input entered from a user to create a botcast for the user (e.g., a selection of a menu item to create a botcast—prior to or subsequent to selecting the content for the botcast—and which will trigger processes for creating the botcast from previously selected content and/or for the user to manually select the content for the botcast and/or for the system to automatically identify and select the content for the botcast).

In some instances, the user input for triggering the selection of content and/or for triggering the creation of a botcast includes a user selection of a botcast control icon presented in an application that generates content (e.g., icon described in FIGS. 8-10), which when selected, triggers the creation of a botcast for content provided by the application. Other explicit user input for selecting content and/or for triggering the botcast processing/functionality includes a user indicating that highlighted or tagged portions of content should be include in a botcast.

Other examples of user input for triggering disclosed functionalities are more indirect and not as isolated, such as user input that received incrementally/periodically over a duration of time, such as when a user incrementally/collectively selects a predetermined quantity of content resources or content to include in a botcast. In such instances, for example, once a threshold quantity of resources has been selected and/or total magnitude of content has been selected by the user over any duration of time, the system will trigger the processes required to create and configure the podcast based on the selected content.

Additionally or alternatively, the content selector and other models perform their functionality automatically according to predetermined schedules (e.g., once a day, once a week, etc.) and/or in response to detecting certain events independent of user input (e.g., detecting an urgent communication directed to the user, detecting a meeting or other event has concluded or is about to take place, in response to detecting a broadcast or notification regarding content from a third party, detecting numerous new resources of content, etc.). Each of these events can be a triggering condition. Additionally, each of the triggering conditions can be a triggering condition for selecting content and/or for more broadly generating a new botcast for a particular user and/or modifying an existing botcast for a particular user.

It will also be noted that the computing system will automatically access the one or more profile or preference settings of the particular user, which is stored in memory and/or other storage, in response to any of the triggering events or conditions described herein, which may reflect or comprise a trigger for generating or modifying a botcast for the particular user;

By applying one or more of the functions and processes described above, the content selector is enabled to identify and select the content for user botcasts that is determined to be sufficiently relevant to the corresponding and particular user(s) that the botcasts are being created or modified for. The content selector then obtains the selected content, from memory and/or other storage, which may include entire resources and/or discrete subsets or segments of the resources, and which may be configured as different types and in different formats, including various forms of text data, audio data, image data, video data, mixed-media data.

After content has been selected by the content selector model, with or without explicit user input, it is processed by the other ML models, as will now be described, and each of which is based at least in part on the user preference and profile data, such that the resulting botcasts are configured in a personalized format with content that is determined to be relevant to the corresponding users.

As shown in FIG. 2, the selected content is processed by the sequencer model, transition model and the formatting model to create the final botcasts (i.e., botcast media file(s) which comprise formatted audio files and/or other file structures that are configured to be processed and rendered as audio). As also shown, the configured botcasts are then further utilized by the modification model that modifies the botcasts and/or by the presentation model that presents the botcasts for publication, storage and/or audio play.

Each of the foregoing models are trained with training data to perform their functionalities, as generally described above with reference to the content selector model. The training and training data sets may be unique to each model and/or may be shared between the different models.

In some instances, the sequencer model is trained to sequence different portions of the selected content into sequences based on relative importance/relevance. The training data includes different pairings of relevance valuations with sequence and ordering rules. The sequencer model is also trained with pairings of relevance valuations with circumstantial and contextual information to re-evaluate/modify relevance valuations. In this manner, the trained sequencer model is enabled to evaluate user profile data (including new and dynamic context/circumstances) to re-evaluate the relevance valuations of the different selected content, based on the new and dynamic context/circumstances and/or other updated profile data, subsequent to the initial identification of the selected content. This can be important, particularly when the selected content is identified over a lengthy period of time and/or prior to a significant new contextual event has occurred that is relevant to the user.

Once the sequencer model has sequenced the different selected content, which may include one or multiple resources and/or resource segments, the transition model creates transitions for each of the different content segments/resources that are to be included in the botcast for the user.

The transition model is trained with various training data sets, to accommodate different needs and preferences, and to perform desired analysis of the selected content and to generate transitions for the content that summarize the context of the content and/or to clarify the relevance of the content to the user in a personalized manner for the user, based on different preference and profile settings of the user.

The analysis and processing performed by the transition model on the content includes, but is not limited to, any combination of natural language processing and analysis, image processing and analysis, context analysis, video analysis, body language analysis, intonation analysis, emotional processing, concept inclusion analysis and/or other processing and analysis of underlying content (e.g., text, audio, video, images) to determine context and/or other characterizing information of the content that can be used to characterize relevance of the content to the user. In some instances, the transition model evaluates metadata associated with the content to obtain information associated with timing, location, participants and/or other contextual information related to the content.

Any combination of the foregoing processing is performed by the transition model during implementation, as appropriate for the corresponding types of content, to identify key terms, key phrases, authors, instructions, tasks, intentions, concepts, summaries, participants, deadlines, events, dates, times, emphasis, and emotional tones, for the underlying content. Alternatively, the transition model obtains results of such analysis from the content selector model if the content selector model already performed such an analysis on the content.

As described, the transition model is enabled to perform functionality for identifying context and relative relevance of the selected content to a user and to summarize this context/relevance in a message that is spoken to the user. The transition, which prepends the corresponding content, can be helpful for enabling a user to selectively decide whether to listen to the actual content or not. Such a transition can also be helpful to clarify what the user is listening to and to prepare the user for changes in the current content from previous content in the botcast that may be related to completely different topics or concepts.

By way of simple example, if the selected content comprises a selected portion of a recorded meeting, the transition model can include an audio message that identifies context or relevance of the meeting for the particular user to prepare the user for what they are going to hear. By further of simple example, the transition for the meeting might summarize the context/relevance of the meeting for a particular user in the following way “This is where your Boss instructed you to perform task A during all hand meeting on a date Y,” or “In the meeting last Thursday, you presented your summary on the project progress to the group. Meeting attendees included people A,B,C, . . . ”, or “Person A said this to you and about you in the email they referenced during the meeting.”. It will be appreciated that there is an endless variety of transition messages that can be created, depending on the underlying content and the determined relevance/context to the particular user. The messages may convey information spoken by or about the user, temporal information associated with a scheduled calendar event associated with the particular user, and/or any other relevant information.

Additionally, when the selected content applies to multiple different entities or individuals, the transition model (and other models) can perform their functionality for each of the different entities/individuals separately and can configure/utilize different versions of a similar botcast having similar or the same underlying selected content. For instance, when an enterprise has a botcast created with selected content applicable to a plurality of different members, the transition model will still customize/personalize a plurality of discrete botcast versions of the same underlying botcast, with the same underlying content, but different customized/personalized transitions for each individual that personalize/customize how the content is summarized to the individual and/or how the relevance of the content to each individual is characterized.

Another manner in which the transitions are customized and/or personalized includes generating the speaking style with a language, prosody, timbre and/or other speaking attribute that is preferred by the different users to use for the summary of the content in the transition, which is selected from a plurality of different summary formats based on profile or preference settings of the different users. This speaking attribute information or profile data that can be used to ascertain the preferred speaker attributes are included in the user profile data mentioned previously.

In this regard, it will be appreciated that the prosody and language selected for presenting the transition messages and/or that is selected for presenting content that is converted into an audio format can be automatically and/or manually identified/selected from a plurality of different available prosodies and languages, based on preconfigured settings, or based on contextual environmental/user conditions (e.g., detected user, geography, mood, or other user profile data) and/or based on explicit user input and/or system settings.

In some embodiments, the transition summary/message format and prosody that is used, which is selected from a plurality of different summary/message formats, will be based on different prosody style attributes, such as speaking styles of a particular target speaker and/or a style mode of speaking (e.g., John Wayne or western style, storytelling style, news reporting style, comedic style, intellectual style, etc.). Some prosody attributes associated with the prosody style also include typical human-expressed emotions such as a happy emotion, a sad emotion, an excited emotion, a nervous emotion, or other emotion. Oftentimes, a particular speaker is feeling a particular emotion and thus the way the speaker talks is affected by the particular emotion in ways that would indicate to a listener that the speaker is feeling such an emotion. As an example, a speaker who is feeling angry may speak in a highly energized manner, at a loud volume, and/or in truncated speech. In some embodiments, a speaker may wish to convey a particular emotion to an audience, wherein the speaker will consciously choose to speak in a certain manner. For example, a speaker may wish to instill a sense of awe into an audience and will speak in a hushed, reverent tone with slower, smoother speech. It should be appreciated that in some embodiments, the prosody styles are not further categorized or defined by descriptive identifiers.

The disclosed systems and models are configured to select a prosody/style of speech, from a plurality of available prosodies/styles/languages, based on the user profile data that reflects a relevance of a particular prosody/style to the user and/or the content.

In some instances, the user profile data also specifies whether music or other background sounds or affects should be used with the transition messages when they are presented. Some affects can be used to emphasize the messages and/or to make the message more pleasant to listen to and/or help the listener know that they are listening to a transition rather than the underlying content.

The formatting model is trained to prepend transitions to different content and content segments that they are associated with. This training and processing includes formatting all of the content into a common format (e.g., an audio format or another format that can be processed by the presentation model and/or an audio media player in the form of audio).

When the content comprises images, text, videos, or formats other than audio, the formatting model converts the content into a common format. This process may include summarizing the concepts and contexts of the non-audio content into text and then performing natural language processing to generate audio representations of the text. In some instances, this also includes generating audio representations that are formatted to render the audio in a particular language or speaking style. Techniques for converting text to language are known and will not be described in detail at this time. Importantly, however, the formatting model selects the speaking style to use for the audio representation, from a plurality of available speaking styles available to the formatting model, based on the profile data of the user associated with the botcast for which the transition is to be created.

When multiple listeners/users are going to receive botcasts having the same underlying selected content and/or the same transition message(s), the formatting model will still generate different formatted transitions for each user, with each formatted transition being formatted with a speaking style (e.g., language, prosody, timbre, etc.) and/or presentation style (e.g., with sound effects, with background music, etc.) that is unique to the user relative to other users, based on their unique set of user preferences and profile data.

The formatting model creates the botcast media file having the transitions prepended before each of the different corresponding portions of content in the botcast file, as a single integrated audio file. The formatting model also formats the botcast with tags, markers and/or index features that identify the start and stop portions of each transition and corresponding content within the botcast, so as to enable a media player to jump to the different portions of the botcast for playback.

In some alternative embodiments, the formatting model creates a playlist of the transitions and content segments for the botcast, which are each stored separately, but presented and/or played together in the sequenced ordering during playback.

In other alternative embodiments, the botcast file is formatted into text, containing text that corresponds to the transition messages and the content and which is converted to audio by the presentation model and/or a media player.

The presentation model is trained/configured to present the botcasts to the user for rendering, on demand, through the various interfaces (e.g., FIGS. 11-12) that the user can query and select the botcast from, and/or by sending the botcast files directly to a user device (e.g., a message containing the botcast file or link that is sent to a user's device via a messaging application). The presentation model is also configured to enable playback of the botcasts with various playback functionality (e.g., play, pause, fast-forward to next transition, rewind to previous transition, etc.).

The modification model is configured and trained to identify user input and updated profile data and to further evaluate user playback of different botcasts, to determine whether to modify the botcasts. In some instance, the modification model performs redundant processing performed by the other models to update or modify botcast(s) based on new user input and/or updated profile data. In other instances, the modification model causes the other models to implement their processes iteratively, relative to the existing botcast and/or with newly discovered content and/or new user profile data, and which causes a change to content and/or the transition(s) in the existing botcast(s).

In some instances, the modification processing causes validating or invalidating of content in the botcasts for particular users. In particular, the modification processing may diminish relative relevance of content in a botcast fora particular user based on the new/updated profile data and contextual circumstances of the user(s) and/or based on newly discovered content and/or based on a determination the user has already listened to some of the content.

When the relative relevance of the content in a botcast changes for a particular user, the modification model is configured to cause the botcast to be modified by omitting, resequencing, reformatting, replacing and/or otherwise modifying the content and/or the corresponding transition(s) for the content in the botcast. In some instances, the modifications merely resequences the content in the botcast by newly determined relevance, with the more urgent/prioritized/relevant content being sequenced before relatively less urgent, prioritized, or relevant content in the botcast.

Attention will now be directed to FIGS. 3A-3B, which illustrate a content selection UI 300 that can be used by a user to select from a selection of possible resources to identify and select content for a botcast. The listing of resources can be made through directory of resources (e.g., a user's database of recordings and other content, for example). The system will, in some instances, query for available resources in a particular domain or directory in response to user input identifying the domain/directory from an initial query entered on an interface to find content for a botcast.

Once the user selects one of the resources to use for the botcast, as shown in FIG. 3B, the system parses the selected content/resource into a plurality of different segments, as described previously, for subsequent identification/selection. This is shown, for example, in FIG. 3C, where a user is presented with segments 1-6 for file/resource 2, subsequent to the user selecting file/resource for inclusion in the user's botcast. The user is also shown as having now selected segments 1, 3, 5 and 6 for inclusion. In this instance, the botcast will include the content of these segments, while excluding the other segments. If other resources and/or segments are selected, they can also be included in the same or different botcast, according to different embodiments.

As further described, once these segments are selected, a separate transition will be created for each separate content resource and/or segment for the botcast.

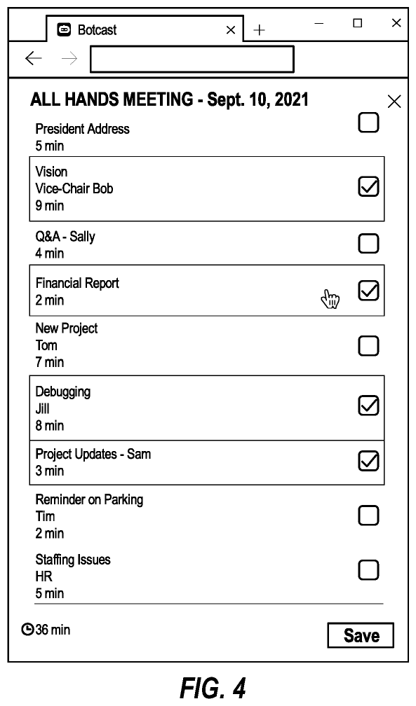

FIG. 4 illustrates another embodiment for selecting content, in this embodiment, an interface is presented with segments of an underlying resource (e.g., a recording of an “All Hands Meeting” conducted Sep. 10, 2021). This resource, after initial selection, has been segmented and presented to the user for subsequent selection. In this embodiment, the segments are further provided with additional details, like duration and speaker information. This information can be used for the transitions and/or merely to help the user determine which segments to select for final inclusion in the botcast.

In some instances, each botcast will be specific to a single resource. In other embodiments, a botcast may include content from multiple different resources.

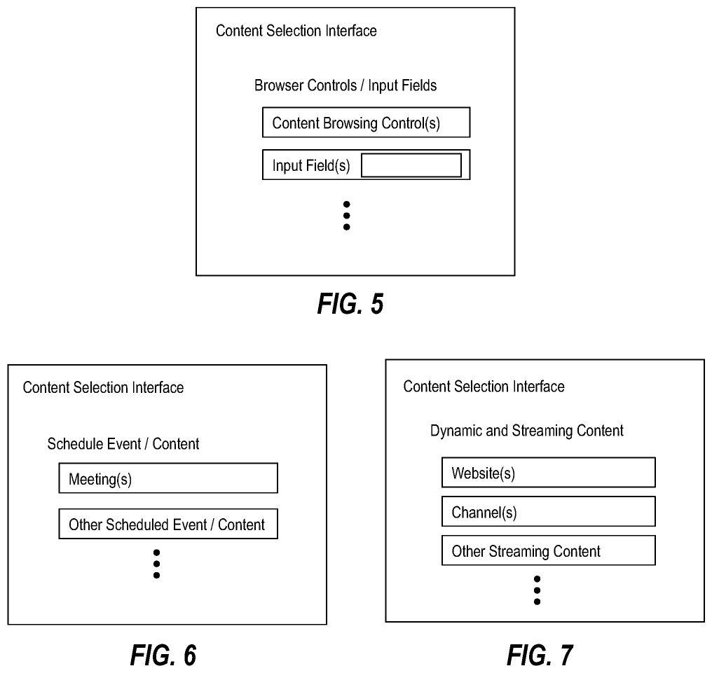

FIGS. 5-7 illustrate additional embodiments for identifying and selecting content. In FIG. 5, an interface is provided with browser controls that are operable, when selected or interacted with by a user to navigate to content for selection. Likewise, input fields can also be used to enable a user to specify the address of a particular resource to include for the selection and other botcast processing described herein.

FIG. 6 illustrates how the selection of content can also include interfaces that present scheduled meeting events and other scheduled events/content (e.g., video conference events, meetings that will be recorded, teleconferences, scheduled releases of publications, etc.). These interfaces may list scheduled meeting or other scheduled events, for example, that are selectable by the user as resources to include for the selection and other botcast processing described herein.

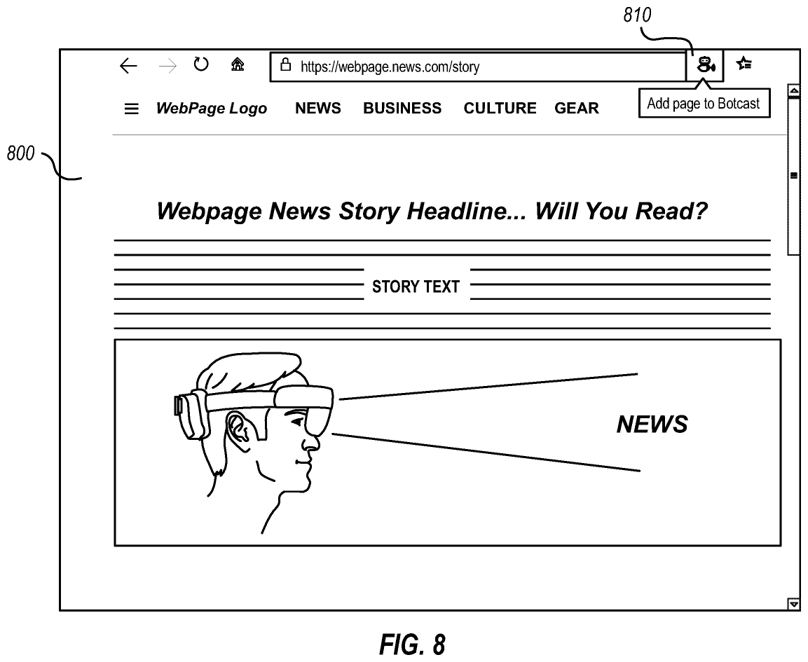

Finally, FIG. 7 illustrates how the selection of content can also include interfaces that present dynamic and streaming content that is available for selection (e.g., website(s), streaming channel(s), and other streaming services/content). These interfaces may list the various dynamic streaming sources as selectable content to undergo the botcast processing described herein.

FIG. 8 illustrates an embodiment of a web browser showing a webpage of content 800. In this embodiment, a user is enabled to select or flag content for inclusion in a botcast and for the referenced processing by selecting a selectable icon (e.g., icon 810) which, when selected, causes the system to identify the webpage that the icon 810 is displayed with for selection by the content selector model.

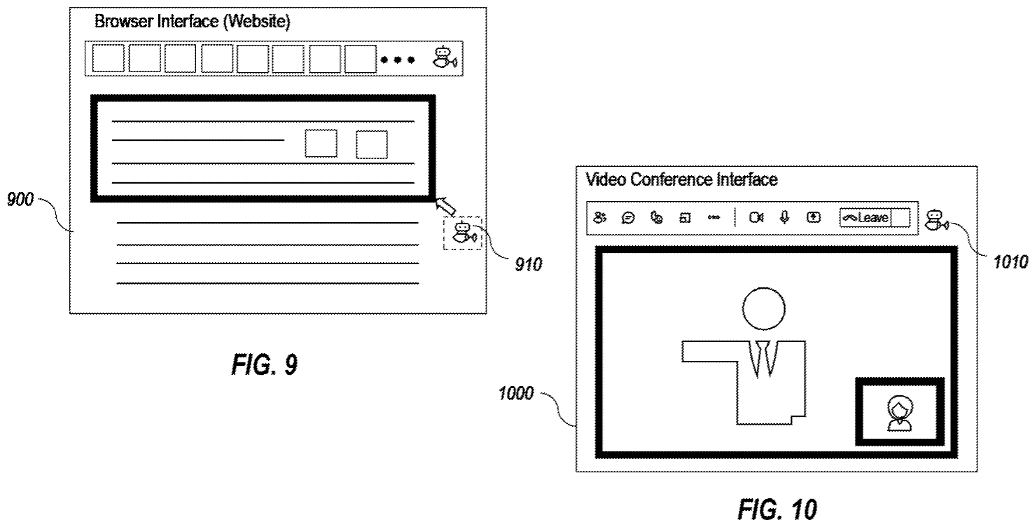

FIG. 9 illustrates a related embodiment, in which a portion of a website 900 is highlighted by a user. In this embodiment, when a user selects and/or highlights a portion of content from a website or other document, the system displays a selectable control 910 which, when selected, causes the highlighted portion of content to be selected by the content selector model for the user's botcast and referenced processing by the ML models.

FIG. 10 illustrates another embodiment, in which a control 1010 is presented with an application 1000, such as a video conferencing application. In this embodiment, when a user selects the control, the content selector model is caused to identify the video conferencing application 1000 and/or a video conference meeting associated with the conferencing application 1000 to be a source of media to include in the selected content.

FIGS. 11 and 12 illustrate embodiments of interfaces (1100 and 1200) that display a set of botcasts associated with and configured for a particular user (1100). These botcasts are currently in interface 1100 as files and are displayed with playback statuses showing total duration, dates of creation and a listening progress bar. Titles for the botcasts are also shown, which may be transcribed portions of the transition messages. Various different metadata and status information can be displayed with the botcasts, including dates referenced in the content, storage locations, expiration dates (if any), modification dates (if any), or any other information. Controls can also be provided for sharing, playing, and deleting the botcasts.

Interface 1200 shows a playback interface for a botcast that is presented when one of the botcasts in interface 1100 is selected. As shown, the interface includes functional buttons which, when selected, enable the user to advance to a previous or subsequent topic (e.g., segment in the botcast—such as when each botcast has multiple topics, and/or to a different botcast—such as when each botcast is focused on a single topic).

Notably, the initial portion of each content audio file/segment of the botcast(s) will include a separate transition, as previously described, to characterize/summarize the relevance of the content in the file/segment to the user.

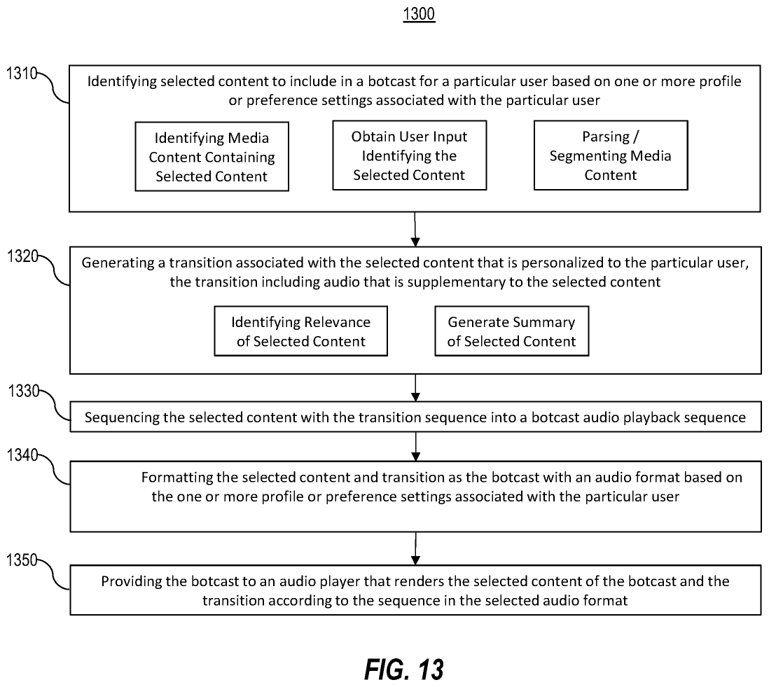

Attention will now be directed to FIG. 13, which illustrates a flow diagram 1300 that includes various acts associated with exemplary methods that can be implemented by computing systems, such as computing system 110 of FIG. 1.

As shown, the flow diagram 1300 includes a plurality of acts (act 1310, act 1320, act 1330, act 1340, and act 1350) which are associated with various methods for configuring and/or using a botcast of media content customized for a particular user or entity based on one or more profile or preference settings associated with the particular user (which may include contextual circumstances associated with the particular user/entity), as well as for generating one or more transitions associated with the selected content that is personalized to the particular user/entity and that will be incorporated into the botcast with the selected content to identify the relevance of the content to the user.

As shown, the first illustrated act (act 1310) includes the system identifying selected content to include in a botcast for a particular user (e.g., a single individual user or, alternatively, an entity comprising a plurality of users). As previously described, the content selection is based on one or more profile or preference settings associated with the particular user and which may include contextual circumstances or conditions associated with the particular user. The system is configured to use the content selector model to perform this act.

In some instances, the system first identifies the user for which the botcast information is to be identified. Then, the system identifies the corresponding stored profile and preference settings and contextual information associated with that user.

Some non-limiting examples of the system identifying the content includes identifying specific content that has been manually or explicitly tagged by the user for use in a botcast through the selection of a botcast content flagging/tagging icon or control for the botcast, for example, or through a user selection or highlighting of content that is identified and/or displayed to the user through one or more content display/identification interfaces, or user input identifying a URL or storage address where the content is located.

Other non-limiting examples for selecting the content include automatically identifying the content based on identifying content that is relevant to a user based on discovering information that is associated with upcoming meetings, missed meetings, project events, scheduled events, assigned tasks, preferential resource topics or resources, or other profile/preference data of the user. This information can be automatically identified by evaluating the different profile/preference data and scanning metadata and information from the profile/preference data that references the identified content and by also determining the referenced content is materially relevant or contextually relevant to the user based on the processing and functionality described throughout, based on a user's profile data.

The next illustrated act (act 1320) includes the system generating a transition associated with the selected content that is personalized to the particular user. This act is performed by the transition model described above.

As previously described, the transition includes an audio message that is supplementary to the selected content and that includes at least one of an identification of a relevance of the selected content to the particular user based on the one or more profile or preference settings associated with the particular user and/or a summary of the selected content that is formatted in a selected summary format that is selected from a plurality of available different summary formats, each of which is based on the one or more profile or preference settings associated with the particular user and which setting may include contextual circumstances associated with the particular user.

The next illustrated act (act 1330) includes the system sequencing the selected content with the transition sequence into a playback sequence that is used by media players for presenting and/or rendering the botcast transition(s) and content in the ordered sequence. This sequencing, which is performed by the sequencer model, is sometimes based on the profile/preference settings and/or contextual circumstances associated with the particular user, as described, and as may be evaluated subsequent to the selection of the content.

The next illustrated act (act 1340) includes the system formatting and/or otherwise linking or assembling the selected content and transition(s) into a digital structure comprising the botcast and with the selected content and transition(s) being stored in an audio format or audio playable format that is selected from a plurality of different audio/audio playable formats, the audio/audio playable format being selected from the plurality of different formats based on the one or more profile or preference settings associated with the particular user and which may include contextual circumstances associated with the particular user.

The formatting is performed by the formatting model described previously and may include formatting the transition and the underlying content into a single botcast audio file.

The next illustrated act (act 1350) includes the system using the presentation model to store the botcast in a particular location or to broadcast, render, share, distribute the botcast to a particular user, device or third party. In some instances, the presentation model provides the botcast to an audio player that renders the botcast (including the selected content and transition(s)) according to the ordering of the botcast sequence and in the format selected for the botcast, based on the particular user settings/circumstances.

Other embodiments also include modifying the botcast for the same user and/or for different users, with the modification model, based on detecting different dynamic changes to user settings, available content and/or contextual circumstances for the user/different users. Such modifications can include adding new content and/or removing content from the botcasts, based on a detected increase/decrease in relevance of the content, respectively, for the different users. The modifications can also include reordering/resequencing of the content and/or transitions in the botcast, reformatting of the content/transitions into different playback audio formats, and/or creating, augmenting, deleting, or otherwise modifying the transitions/content in the botcast.

Other embodiments include identifying and parsing the media content into a plurality of media subcomponents/segments, presenting the plurality of media subcomponents to a particular user for user selection, identifying user input selecting the one or more selected subcomponents from the plurality of media subcomponents, and identifying the one or more selected subcomponents as the selected content.

Other embodiments include presenting each of the plurality of media subcomponents with a textual description of one or more topics associated with each corresponding media subcomponent or segment.

Other embodiments include identifying and selecting content for a botcast that is in a text format and performing TTS (text-to-speech) processing on the selected content to format the selected content into an audio format.

Other embodiments include generating transitions for content selected and wherein the transition includes a summary of the selected content and that is formatted in a summary format (e.g., prosody style and/or other format based on language attributes) and that is selected from a plurality of available different summary formats, based on the one or more profile or preference settings associated with the particular user.

Other embodiments include modifying the botcast by omitting a portion of the selected content that has been determined to have a diminished relevance to the particular user subsequent to a formatting the selected content and transition as the botcast and/or by modifying or deleting the transition associated with the selected content having the portion omitted and/or reformatting the botcast to reflect the selected content with the portion omitted and the modified or deleted transition associated with the selected content having the portion omitted.

In some instances, the modifying is performed dynamically in response to detecting the diminished relevance of the selected content to the particular user, and the system detects the diminished relevance in response to determining the particular user has listened to the portion of the selected content that has been determined to have the diminished relevance.

In other instances, the modifications occur dynamically in response to detecting the diminished relevance of the selected content to the particular user, wherein detecting the diminished relevance comprises detecting change in a scheduled event associated with a calendar of the particular user.

In some instances, the modification includes modifying the botcast by adding new content and by adding a new corresponding transition that is associated with the new content and/or by resequencing the botcast audio playback sequence. The resequencing can include moving the new content and the new corresponding transition to be interposed between at least two other portions of content and at least two other transitions that correspond to the at least two other portions of the content.

Other embodiments include generating derivate, supplemental, or additional botcasts that includes similar or the same underlying content as one or more other botcasts, but which include one or more different transition(s) associated with the content, the different transition being personalized to the different users and omitting transitions that are personalized to other users.

In view of the foregoing, it will be appreciated that the disclosed embodiments include systems and methods for utilizing trained machine learning models for configuring and utilizing botcasts of media content that are personalized and customized for different users based on contexts associated with the users and based on one or more profile or preference settings associated with the users, and in a manner that facilitates computational efficiencies for configuring and utilizing the botcast, and which can reduce the waste of time and computational processing otherwise required by users that attempt to generate their own media compilations of the same content included in the personalized botcasts.

Embodiments of the present invention may comprise or utilize a special purpose or general-purpose computer (e.g., computing system 110) including computer hardware, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media (e.g., storage 140 of FIG. 1) that store computer-executable instructions (e.g., component 118 of FIG. 1) are physical storage media. Computer-readable media that carry computer-executable instructions are transmission media. Thus, by way of example, and not limitation, embodiments of the invention can comprise at least two distinctly different kinds of computer-readable media: physical computer-readable storage media and transmission computer-readable media.

Physical computer-readable storage media, which is distinct and distinguished from transmission computer-readable media, include physical and tangible hardware. Examples of physical computer-readable storage media include hardware storage devices such as RAM, ROM, EEPROM, CD-ROM or other optical disk storage (such as CDs, DVDs, etc.), magnetic disk storage or other magnetic storage devices, or any other hardware which can be used to store desired program code means in the form of computer-executable instructions or data structures and which can be accessed by a general purpose or special purpose computer and which are distinguished from merely transitory carrier waves and other transitory media that are not configured as physical and tangible hardware.

A “network” (e.g., network 130 of FIG. 1) is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmission media can include any network links and/or data links, including transitory carrier waves, which can be used to carry, or desired program code means in the form of computer-executable instructions or data structures, and which can be accessed by a general purpose or special purpose computer. Combinations of the above are also included within the scope of computer-readable media.

Further, upon reaching various computer system components, program code means in the form of computer-executable instructions or data structures can be transferred automatically from transmission computer-readable media to physical computer-readable storage media (or vice versa). For example, computer-executable instructions or data structures received over a network or data link can be buffered in RAM within a network interface module (e.g., a “NIC”), and then eventually transferred to computer system RAM and/or to less volatile computer-readable physical storage media at a computer system. Thus, computer-readable physical storage media can be included in computer system components that also (or even primarily) utilize transmission media.

Computer-executable instructions comprise, for example, instructions and data which cause a general-purpose computer, special purpose computer, or special purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The present invention may be embodied in other specific forms without departing from its spirit or characteristics. The described embodiments are to be considered in all respects only as illustrative and not restrictive. Additionally, it will be appreciated that the scope of the invention also includes combinations of the disclosed features that are not explicitly stated, but which are contemplated, and which can include any combination of the disclosed features that are not antithetical to the utility and functionality of the disclosed models and techniques for performing TTS processing.

The scope of the invention is, therefore, indicated by the appended claims rather than by the foregoing description. All changes which come within the meaning and range of equivalency of the claims are to be embraced within their scope.

What is claimed:

1. A method implemented by a computing system for utilizing trained machine learning models for configuring and utilizing a botcast of content that is personalized and customized for a particular user based on context associated with the particular user and based on one or more profile or preference settings associated with the particular user in a manner that facilitates computational efficiencies for configuring and utilizing the botcast, the method comprising:
the computing system automatically accessing, from memory or storage, the one or more profile or preference settings of the particular user in response to a triggering event for generating or modifying a botcast for the particular user;
identifying media content for selection by a user to include in the botcast for a particular user based on one or more profile or preference settings associated with the particular user;
automatically generating a transition associated with selected content that is selected from the identified media content and that is personalized to the particular user, based on the one or more profile or preference settings of the particular user, the transition including audio that is supplementary to the selected content and that includes at least one of:
an identification of a relevance of the selected content to the particular user based on the one or more profile or preference settings associated with the particular user, or
a summary of the selected content that is formatted in a selected summary format that is selected from a plurality of available different summary formats, based on the one or more profile or preference settings associated with the particular user;
sequencing the selected content with the transition sequence into a botcast audio playback sequence based on the profile or preference settings of the particular user;
formatting the selected content and transition as the botcast with an audio format selected from a plurality of different audio formats, the audio format being selected from the plurality of different audio formats based on the one or more profile or preference settings associated with the particular user; and
providing the botcast to an audio player that renders the selected content of the botcast and the transition according to the sequence in the selected audio format.

2. The method of claim 1, wherein the identifying the selected content to include in the botcast for the particular user further includes:
parsing the media content into a plurality of media subcomponents;
present the plurality of media subcomponents to the particular user for subsequent user selection;
identify user input selecting the one or more selected subcomponents from the plurality of media subcomponents;
identifying the one or more selected subcomponents as the selected content; and
for each selected subcomponent of the one or more selected subcomponents, automatically generating a separate transition corresponding to each selected subcomponent, each transition being automatically generated by a machine learning model that is trained to perform analysis of media content and to generate transitions for the media content that summarize a context and relevance of the media content and in a personalized manner based on the different preference and profile settings of the different users.

3. The method of claim 2, wherein the method further includes presenting each of the plurality of media subcomponents with a textual description of one or more topics associated with each corresponding media subcomponent.

4. The method of claim 2, wherein the user input selecting the media content for subsequent parsing and presentation as the potential content for the selected content comprises a selection of an audio file that includes the selected content and parsing the media content includes parsing the media content into a plurality of audio segments.

5. The method of claim 2, wherein the user input selecting the media content for subsequent parsing and presentation as the potential content for the selected content comprises a selection of a control associated generating the botcast while the media content is presented.

6. The method of claim 5, wherein the user input wherein the media content comprises a webpage and the user input selecting the media content for subsequent parsing and presentation as the potential content for the selected content comprises a selection of an icon on a browser that is displaying the webpage.

7. The method of claim 1, wherein the media content is a file containing the selected content in a text format and wherein the method further includes:
performing TTS (text-to-speech) processing on the selected content to format the selected content into an audio format.

8. The method of claim 1, wherein the transition includes the said identification of the relevance of the selected content to the particular user is based on the one or more profile or preference settings associated with the particular user, the relevance being determined according to a context of the particular user relative to the selected content.

9. The method of claim 8, wherein the transition includes temporal information associated with a scheduled calendar event associated with the particular user.

10. The method of claim 8, wherein the transition includes information referencing a statement made about the particular user in the selected content.

11. The method of claim 8, wherein the transition includes information referencing a statement made by the particular user in the selected content.

12. The method of claim 1, wherein the transition includes the summary of the selected content that is formatted in the selected summary format and wherein the method includes selecting the selected summary format from the plurality of available different summary formats, based on the one or more profile or preference settings associated with the particular user.

13. The method of claim 12, wherein the selected summary format includes a prosody speaking style selected from a plurality of possible prosody speaking styles.

14. The method of claim 1, wherein the identifying the selected content includes identifying the selected content from a plurality of different media content from a corresponding plurality of different media content sources.

15. The method of claim 14, wherein the selected content includes at least some selected content in an audio format and at least some selected content in a text format and wherein formatting the selected content includes converting all of the selected content into the audio format.

16. The method of claim 1, wherein the method further includes modifying the botcast by:
omitting a portion of the selected content that has been determined to have a diminished relevance to the particular user subsequent to a formatting the selected content and transition as the botcast; and
modifying or deleting the transition associated with the selected content having the portion omitted; and
reformatting the botcast to reflect the selected content with the portion omitted and the modified or deleted transition associated with the selected content having the portion omitted.

17. The method of claim 16, wherein the method includes performing the modifying dynamically in response to detecting the diminished relevance of the selected content to the particular user, the method further including detecting the diminished relevance which comprises determining the particular user has listened to the portion of the selected content that has been determined to have the diminished relevance.

18. The method of claim 16, wherein the method includes performing the modifying dynamically in response to detecting the diminished relevance of the selected content to the particular user, the method further including detecting the diminished relevance which comprises a detected change in a scheduled event associated with a calendar of the particular user.

19. The method of claim 1, wherein the method further includes modifying the botcast by:
adding new content to the botcast with a new corresponding transition that is associated with the new content; and
resequencing the botcast audio playback sequence.

20. The method of claim 1, wherein the method further includes generating an additional botcast that includes:
the selected content; and
a different transition associated with the selected content, the different transition being personalized to a different user than the particular user, the additional botcast also omitting the transition associated with the selected content that is personalized to the particular user.

21. The method of claim 1, wherein the media content is identified by a machine learning model that is trained to search and crawl target resources for content that is determined to be relevant to different users based on different user profile or preference settings associated with the different users.

22. The method of claim 1, wherein the summary is generated by a machine learning module that is trained to generate summaries based on contextual relevance to different users and to select formats for formatting the summaries based on the different profile or preference settings associated with the different users.

23. The method of claim 1, wherein the sequencing is performed by a machine learning model that is trained to sequence the selected content into a sequenced playback ordering that is based on relative relevance based on different profile or preference settings associated with different users.
